(19) United States
(12) Patent Application Publication
(10) Pub. No.: US 2020/0266418 A1
(43) Pub. Date: Aug. 20, 2020

(54) GAP SECTION MULTILAYER ELECTRODE PROFILE

(71) Applicant: EnPower, Inc., Phoenix, AZ (US)

(72) Inventor: Adrian YAO, Phoenix, AZ (US)

(73) Assignee: EnPower, Inc., Phoenix, AZ (US)

(21) Appl. No.: 16/488,320

(22) PCT Filed: Mar. 23, 2019
(86) PCT No.: PCT/US19/23790

§ 371 Date: Aug. 23, 2019

Related U.S. Application Data
(60) Provisional application No. 62/647,380, filed on Mar. 23, 2018.

(51) Int. Cl. H01M 4/04; B05D 1/32

(52) U.S. Cl. CPC H01M 4/0404; H01M 4/0435; B05D 1/325

(57) ABSTRACT

Systems and methods of the present disclosure include applying a mask to a substrate before coating the substrate with a multilayer composite to form an electrode. The mask may be removed to produce desired gaps in the coating for further manufacturing of wound battery cell designs and the like. In some examples, the mask comprises a single-sided thermal-release tape.

### CROSS-REFERENCES

This application claims the benefit under 35 U.S.C. § 119(e) of the priority of U.S. Provisional Patent Application Ser. No. 62/647,380, filed Mar. 23, 2018, the entirety of which is hereby incorporated by reference for all purposes.

### FIELD

This disclosure relates to systems and methods for relating to the manufacture of electrochemical devices. More specifically, disclosed embodiments relate to multilayer electrodes for batteries, and the manufacturing thereof.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), lithium ion (Li-ion), and lithium ion polymer (Li-ion polymer).

### SUMMARY

The present disclosure provides systems, apparatuses, and methods relating to electrode manufacturing for lithium ion batteries and the like.

In some embodiments, a method of manufacturing an electrochemical cell electrode may include: adhering a mask to a current collector substrate in a selected pattern; adding a multilayer composite coating to the current collector substrate by forming a first layer by coating a first active material composite onto the current collector substrate and the mask, and forming a second layer by coating a second active material composite onto the first layer; heating the composite coating in an oven, such that the first layer, the second layer, and the mask are dried; removing the mask from the current collector substrate, such that corresponding portions of the first layer and the second layer are removed from the current collector substrate and gaps are formed in the composite coating, each of the gaps comprising a bare area of the current collector substrate.

In some embodiments, a method of manufacturing an electrochemical cell electrode, the method comprising: applying a mask directly to a current collector substrate in a selected pattern, wherein the mask includes an adhesive tape; adding a multilayer composite coating to the current collector substrate by forming a first layer by coating a first active material composite onto the current collector substrate and the mask, wherein the first active material composite includes a plurality of first active material particles, and forming a second layer by coating a second active material composite onto the first layer, wherein the second active material composite includes a plurality of second active material particles; heating the composite coating such that the first layer, the second layer, and the mask are dried; removing the mask from the current collector substrate, such that corresponding portions of the first layer and the second layer are removed from the current collector substrate and gaps are formed in the composite coating, each of the gaps comprising a bare area of the current collector substrate.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic sectional view of an illustrative electrochemical cell.

FIG. 2 is a schematic sectional view of a portion of an electrochemical cell having a first illustrative multilayered electrode, depicted accepting lithium ions in a lithiation process.

FIG. 3 is a schematic sectional view of a portion of an electrochemical cell having a second illustrative multilayered electrode, depicted releasing lithium ions in a delithiation process.

FIG. 4 is a flow chart depicting steps of an illustrative method for manufacturing electrodes in accordance with aspects of the present disclosure.

FIG. 5 is a schematic diagram of an illustrative slot die manufacturing system suitable for manufacturing electrodes in accordance with aspects of the present disclosure.

FIG. 6 is a schematic diagram of an illustrative electrode coating on a substrate, depicting an example of a gap produced in the coating.

FIG. 7 is a sectional side view of a first illustrative example of a problematic gap formed in a multilayered electrode coating on a substrate.

FIG. 8 is a sectional side view of a second illustrative example of a problematic gap formed in a multilayered electrode coating on a substrate.

FIG. 9 is a sectional side view of a third illustrative example of a problematic gap formed in a multilayered electrode coating on a substrate.

FIG. 10 is a schematic side view of an illustrative substrate.

FIG. 11 is a schematic side view of the substrate of FIG. 10 with an illustrative mask applied thereon.

FIG. 12 is a schematic side view of the substrate and mask of FIG. 11 with a multilayered composite material deposited thereon.

FIG. 13 is a schematic side view of the substrate, mask, and composite material of FIG. 12, shown drying.

FIG. 14 is a schematic side view of the substrate and composite of FIG. 13, with the mask and a portion of the composite removed.

FIG. 15 is a schematic side view of a portion of an illustrative electrode manufactured using methods of the present disclosure.

FIG. 16 is an overhead view of a first example of a masking pattern or topology.

FIG. 17 is an overhead view of a second example of a masking pattern or topology.

FIG. 18 is an overhead view of a third example of a masking pattern or topology.

FIG. 19 is an illustrative electrode ribbon having a coating gap produced by the first masking pattern as shown in FIG. 16.

FIG. 20 is an illustrative electrode ribbon having a coating gap produced by the second masking pattern as shown in FIG. 17.

FIG. 21 is an illustrative electrode ribbon having a coating gap produced by the third masking pattern as shown in FIG. 18.

### DETAILED DESCRIPTION

Various aspects and examples of systems and methods for manufacturing electrodes having patterned gaps in the electrode coating, as well as related devices and methods, are described below and illustrated in the associated drawings. Unless otherwise specified, an electrode manufacturing system or method in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; and (4) Conclusion. The Examples, Components, and Alternatives section is further divided into subsections A through D, each of which is labeled accordingly.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Secondary battery” means a rechargeable battery, e.g., a type of electrical battery which can be charged, discharged by a load, and recharged multiple times.

“Coupled” means connected, either permanently or releasably, whether directly or indirectly through intervening components.

### Overview

In general, an electrochemical cell described herein may be, for example, a lithium ion battery with at least one electrode having multiple layers. An electrochemical cell may be another energy storage device, such as a super capacitor, alkali-ion battery other than lithium, lithium-air battery or the like. In some embodiments, an electrode with multiple layers in accordance with aspects of the present disclosure may include: a current collector substrate; and an active material composite layered onto the substrate, wherein the active material composite comprises: a first layer including a plurality of first active material particles; a second layer comprising a plurality of second active material particles and a plurality of non-active ceramic particles. In some embodiments, an electrode with multiple layers in accordance with aspects of the present disclosure may include: a current collector substrate; and an active material composite layered onto the substrate, wherein the active material composite comprises: a first layer including a plurality of first active material particles; a second layer comprising a plurality of second active material particles and a plurality of non-active ceramic particles that are porous and ionically conductive.

An electrode (or a layer of the electrode) may have a thickness measured along a direction perpendicular to the plane of a current collector to which the electrode is adhered, between the current collector and an opposing surface of the electrode. The opposing surface (also called the upper surface) may be substantially planar. This upper surface of the electrode may mate with a separator, a gel electrolyte, or a solid electrolyte when the electrode is included in a cell. In some examples, an electrode having multiple layers of the present disclosure may have a thickness between 10 μm and 300 μm.

A gap section in multilayer electrode coatings on foil should have clean profiles with sharp or abrupt terminations in the coating. This is especially beneficial for wound-type cell designs that require “skip coating” or gap sections along the web direction. With standard single-layer electrode coatings, slot-die coating heads may be actuated to engage/disengage, or slurry valves feeding the slot-die may be turned on and off to create these gaps. However, this is a particular challenge for multilayer coatings, as there are at least two slurries that have different rheologies, all of which must simultaneously end abruptly. Moreover, this should be done without one layer “wrapping” the other layer, or terminating in an unexpected way. Similarly, engaging and restarting a coating after a “gap” may not result in an electrode structure that is anticipated, and the transient to stabilize may be on a length and time scale that is inappropriate for Li-ion battery coatings.

In any Li-ion battery, the preservation of a highly uniform electrode coating is important for longevity and power performance. Loss of uniformity, and specifically, loss of a desired multilayer (ML) structure, can result in different local mass loadings and capacity loadings. This results in local heterogeneity that in turn can cause local areas of higher state of charge (SOC), current density, overcharge, etc. These present areas of the electrode that can cause cell failures. For example, locations for hot spots or lithium-plating may form, and either cause the cell longevity to suffer or result in an internal short circuit. Keeping the ML structure intact with a relatively sharp edge helps ensure the electrode performance is uniform across all areas.

As described below, using methods of the present disclosure, an abrupt, sharp, 90° termination of the multilayer coating may be produced for areas that need a “gap” section. Masking prior to slot-die coating is one method where a thin, heat releasable tape (for example) is applied to the bare substrate prior to coating. The coating is then applied onto the substrate having the masked areas. The coating is dried in an oven, where the masking (e.g., tape) releases its adherence to the substrate. Once removed, a clean gap section is revealed, without residue, for subsequent low-resistance tab/terminal welds.

A second method may include scraping and/or notching electrodes with an abrasive brush or the like. In this method, multilayer electrode coatings are completed in continuous, uninterrupted runs, then dried and optionally calendered. A portion of the coating where a gap section is needed is then scraped clean to reveal bare foil.

### Examples, Components, and Alternatives

The following sections describe selected aspects of exemplary electrode gap formation methods, as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

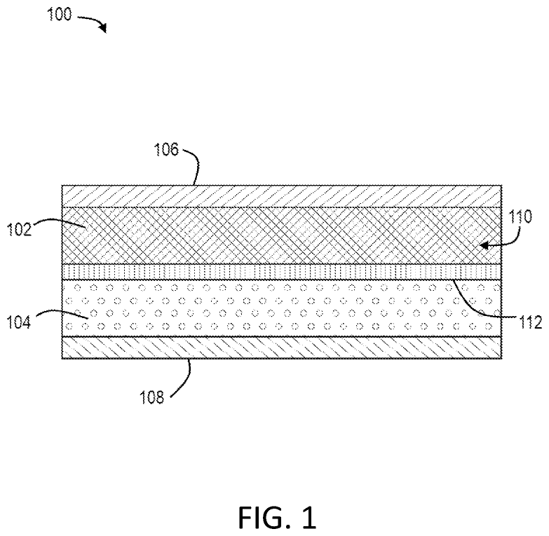

With reference to FIG. 1, an electrochemical cell 100 is illustrated in the form of a lithium-ion battery. Electrochemical cell 100 is an example of a type of electrochemical cell suitable for including one or more of the electrodes described herein. Cell 100 includes a positive and a negative electrode, namely a cathode 102 and an anode 104. The cathode and anode are sandwiched between a pair of current collectors 106, 108, which may comprise metal foils or other suitable substrates. Current collector 106 is electrically coupled to cathode 102, and current collector 108 is electrically coupled to anode 104. The current collectors enable the flow of electrons, and thereby electrical current, into and out of each electrode. An electrolyte 110 disposed throughout the electrodes enables the transport of ions between cathode 102 and anode 104. In the present example, electrolyte 110 includes a liquid solvent and a solute of dissolved ions. Electrolyte 110 facilitates an ionic connection between cathode 102 and anode 104.

Electrolyte 110 is assisted by a separator 112, which physically partitions the space between cathode 102 and anode 104. Separator 112 is liquid permeable, and enables the movement (flow) of ions within electrolyte 110 and between each of the electrodes. In some embodiments, electrolyte 110 includes a polymer gel or solid ion conductor, augmenting or replacing (and performing the function of) separator 112.

Cathode 102 and anode 104 are composite structures, which comprise active material particles, binders, conductive additives, and pores (void space) into which electrolyte 110 may penetrate. An arrangement of the constituent parts of an electrode is referred to as a microstructure, or more specifically, an electrode microstructure.

In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber.

In some examples, the chemistry of the active material particles differs between cathode 102 and anode 104. For example, anode 104 may include graphite (artificial or natural), hard carbon, titanate, titania, silicon monoxide, transition metals in general, elements in group 14 (e.g., carbon, silicon, tin, germanium, etc.), oxides, sulfides, transition metals, halides, and chalcogenides. On the other hand, cathode 102 may include transition metals (for example, nickel, cobalt, manganese, copper, zinc, vanadium, chromium, iron), and their oxides, phosphates, phosphites, and silicates. The cathode may also include alkalines and alkaline earth metals, aluminum, aluminum oxides and aluminum phosphates, as well as halides and chalcogenides. In an electrochemical device, active materials participate in an electrochemical reaction or process with a working ion to store or release energy. For example, in a lithium-ion battery, the working ions are lithium ions.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

For electrochemical cell 100 to properly function as a secondary battery, active material particles in both cathode 102 and anode 104 must be capable of storing and releasing lithium ions through the respective processes known as lithiating and delithiating. Some active materials (e.g., layered oxide materials or graphitic carbon) fulfill this function by intercalating lithium ions between crystal layers. Other active materials may have alternative lithiating and delithiating mechanisms (e.g., alloying, conversion).

When electrochemical cell 100 is being charged, anode 104 accepts lithium ions while cathode 102 donates lithium ions. When a cell is being discharged, anode 104 donates lithium ions while cathode 102 accepts lithium ions. Each composite electrode (i.e., cathode 102 and anode 104) has a rate at which it donates or accepts lithium ions that depends upon properties extrinsic to the electrode (e.g., the current passed through each electrode, the conductivity of the electrolyte 110) as well as properties intrinsic to the electrode (e.g., the solid state diffusion constant of the active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging) anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is lesser than the first rate, the second rate of the cathode would be a limiting rate. In some examples, the differences in rates may be so dramatic as to limit the overall performance of the lithium-ion battery (e.g., cell 100). Reasons for the differences in rates may depend on the mobility of lithium-ions in the liquid phase of the electrolyte, which is affected by the tortuosity of the porous electrode composite structure.

### B. Illustrative Electrode Layer Structures

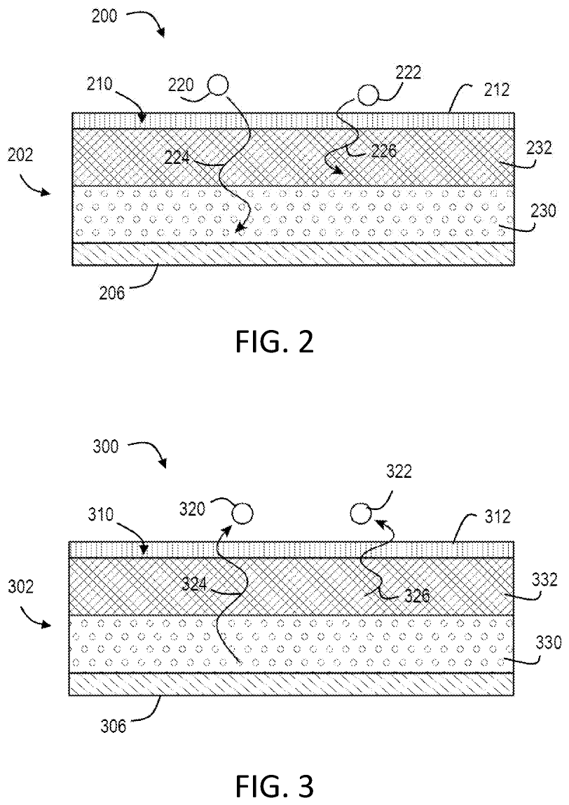

As shown in FIGS. 2 and 3, this section describes illustrative electrodes incorporating multiple composite layers. With reference to FIG. 2, a schematic sectional view of a portion of an electrochemical cell 200 is depicted. Cell 200 has a multilayered electrode 202, shown accepting lithium ions 220 and 222 during a lithiation process. Cell 200 is an example of electrochemical cell 100 of FIG. 1, and includes a separator 212, an electrolyte 210, and a current collector 206. Electrode 202 may be a cathode or an anode, and includes a first layer 230 and a second layer 232. First layer 230 is adjacent current collector 206; second layer 232 is located adjacent (intermediate) the first layer and separator 212. For consistency, all examples of the present disclosure follow a similar convention, where the “first” layer is defined adjacent the current collector and the “second” layer is defined adjacent the separator. First layer 230 and second layer 232 may each be substantially planar, with thicknesses measured relative to a direction perpendicular to current collector 206.

In the present example, electrode 202 is depicted as accepting lithium, for example under a constant potential or constant current, whereby lithium ions 220 and 222 are induced to react (e.g., intercalate) with active material present within first layer 230 and second layer 232. Lithium ions 220 and 222 migrate toward current collector 206 under diffusive and electric field effects. In this example, ion 220 follows a path 224 within electrolyte 210, through separator 212, second layer 232, and a portion of first layer 230, until it lithiates an active material particle within first layer 230. In contrast, lithium ion 222 follows a path 226 within electrolyte 210, through separator 212 and a portion of second layer 232, until it lithiates an active material particle within second layer 232.

In general, path 224 of the ion traveling through the separator to active material within the first layer will be longer than path 226 of the ion traveling through the separator to active material within the second layer. Additionally, the ion on path 224 travels a longer distance while in second layer 232 than does the ion on path 226.

In this example, a thickness of second layer 232 is chosen to be equal to or less than a selected maximum thickness. The maximum thickness is determined by the microscopic architecture of second layer 232, i.e., active material particles with distinct shapes and sizes arranged in a particular way in three-dimensional space. The factors that describe this microscopic architecture include a distribution of the active material particle sizes, a porosity, and a tortuosity within the second layer. If second layer 232 has a thickness greater than the maximum thickness, transport through the second layer to the first layer may become overly tortuous.

With respect to the electrode of FIG. 2, whether an anode or a cathode, the first active material particles of the first layer may have a first distribution of sizes (e.g., by volume) smaller than a second distribution of sizes (e.g., by volume) of the second active material particles of the second layer. In some examples, the first distribution may be smaller than the second distribution by having a median particle size (e.g., by volume) smaller than a median particle size (e.g., by volume) of the second distribution. In some examples, the first distribution may be smaller than the second distribution by having a mean particle size (e.g., by volume) smaller than a mean particle size (e.g., by volume) of the second distribution. In some examples, the first distribution may be smaller than the second distribution by having one or more modes of particle size (e.g., by volume) smaller than a lowest mode of particle size (e.g., by volume) of the second distribution. In some examples, the first distribution may be smaller than the second distribution by having a tenth percentile of the first distribution smaller than a tenth percentile of the second distribution.

Turning now to FIG. 3, a schematic sectional view of a portion of an electrochemical cell 300 is depicted. Cell 300 has a multilayered electrode 302, shown donating lithium ions 320 and 322 during a delithiation process. Cell 300 is an example of electrochemical cell 100 of FIG. 1. The electrochemical cell includes a separator 312, an electrolyte 310, and a current collector 306. Electrode 302 may be a cathode or an anode, and includes a first layer 330, and a second layer 332. Per the convention described above, first layer 330 is adjacent to current collector 306, and second layer 332 is disposed adjacent (intermediate) the first layer and separator 312. First layer 330 and second layer 332 may each be substantially planar, with thicknesses measured relative to a direction perpendicular to current collector 306.

In the present example, electrode 302 is depicted donating lithium, for example under a constant potential or constant current, whereby lithium ions 320 and 322 are induced to react (e.g., deintercalate) and are released from active material present within first layer 330 and second layer 332. Lithium ions 320 and 322 migrate toward separator 312 under diffusive and electric field effects. Lithium ion 320 is shown delithiated (released) from an active material particle within first layer 330, then following a path 324 within electrolyte 310 through a portion of first layer 330, second layer 332, and separator 312. In contrast, lithium ion 322 is shown delithiated from an active material particle within second layer 332, then following a path 326 within electrolyte 310 through a portion of second layer 332 and separator 312.

In general, path 324 of lithium ion 320 traveling from within first layer 330 to separator 312 will be longer than path 326 of lithium ion 322 traveling from within second layer 332 to separator 312. Furthermore, a first distance between the start of path 324 and the separator is greater than a second distance between the start of path 326 and the separator.

In this example, a thickness of second layer 332 is chosen to be equal to or less than a selected maximum thickness. The maximum thickness is determined by the microscopic architecture of second layer 332, i.e., active material particles with distinct shapes and sizes arranged in a particular way in three-dimensional space. The factors that describe this microscopic architecture include a distribution of the active material particle sizes, a porosity, and a tortuosity within the second layer. If second layer 332 has a thickness greater than the maximum thickness, transport through the second layer to the separator may become overly tortuous.

With respect to the electrode of FIG. 3, whether an anode or a cathode, the first active material particles of the first layer may have a first distribution of sizes (e.g., by volume) larger than a second distribution of sizes (e.g., by volume) of the second active material particles of the second layer. In some examples, the first distribution may be larger than the second distribution by having a median particle size (e.g., by volume) larger than a median particle size (e.g., by volume) of the second distribution. In some examples, the first distribution may be larger than the second distribution by having a mean particle size (e.g., by volume) larger than a mean particle size (e.g., by volume) of the second distribution. In some examples, the first distribution may be larger than the second distribution by having one or more modes of particle size (e.g., by volume) larger than a lowest mode of particle size (e.g., by volume) of the second distribution. In some examples, the first distribution may be larger than the second distribution by having a tenth percentile of the first distribution larger than a tenth percentile of the second distribution.

### C. Illustrative Manufacturing System and Method

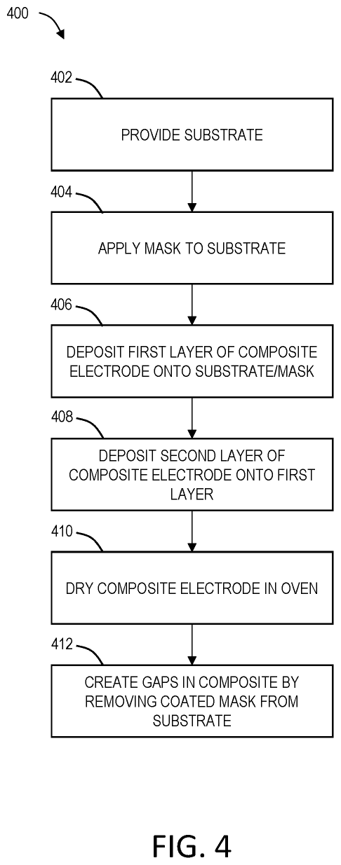

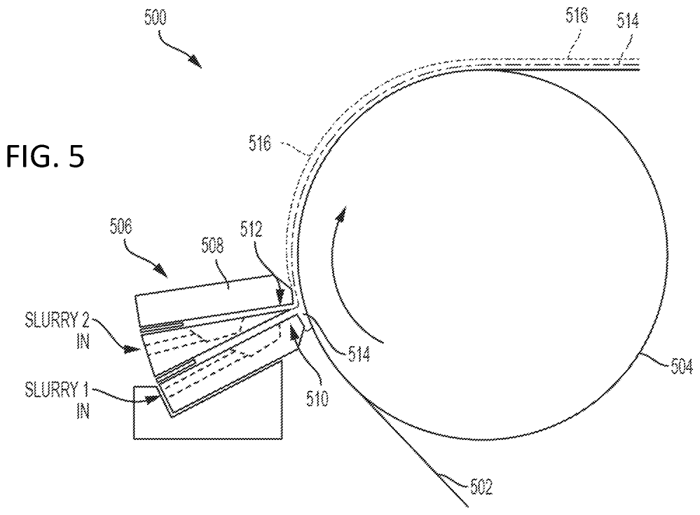

This section describes steps of an illustrative method 400 for forming an electrode including multiple layers; see FIGS. 4-5.

Aspects of electrodes and manufacturing devices described herein may be utilized in the method steps described below. Where appropriate, reference may be made to components and systems that may be used in carrying out each step. These references are for illustration, and are not intended to limit the possible ways of carrying out any particular step of the method.

FIG. 4 is a flowchart illustrating steps performed in an illustrative method, and may not recite the complete process or all steps of the method. Although various steps of method 400 are described below and depicted in FIG. 4, the steps need not necessarily all be performed, and in some cases may be performed simultaneously, or in a different order than the order shown.

Step 402 of method 400 includes providing a substrate, wherein the substrate includes any suitable structure and material configured to function as a conductor in a secondary battery of the type described herein. In some examples, the substrate comprises a current collector, such as current collectors 206, 306 (and others) described above. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out.

Step 404 of method 400 includes applying a mask to the substrate of step 402. This mask may include any suitable material and/or structure configured to adhere to the substrate and prevent it from being coated by the active material composite deposited in subsequent steps. In examples described herein, a suitable mask may be provided using an adhesive tape. The tape material may comprise a polyester (e.g., PET), or a polyimide (e.g., Kapton polyimide). In some examples, a polyester material may provide a lower cost alternative. Adhesive on the tape material may include any suitable adhesive configured to withstand oven drying temperatures (e.g., approximately 90-150° C.) and be physically removable after drying. In some examples, this includes an adhesive configured to release from the underlying substrate (i.e., current collector) in the approximately 90-150° C. temperature range, such that the masking tape releases from the current collector upon slurry drying in the oven, and may be brushed off after the oven exit. In some examples, a single-sided, heat-release (AKA thermal release), PET tape having a film thickness of approximately 3 μm to approximately 15 μm may be suitable, e.g., with an adhesive strength of around 3.7 N/20 mm and, e.g., a forming temperature of approximately 90C. In some examples, lower adhesive strength may be utilized, e.g., 2.5 N/20 mm. Film thickness is generally kept low, e.g., to reduce non-uniformities in the coating steps and to pass unimpeded under slot-die lips (when used).

Method 400 next includes a plurality of steps in which at least a portion of the substrate is coated with an active material composite. This may be done by causing the substrate to move past an active material composite dispenser (or vice versa) that coats the substrate as described below. The composition of active material particles in each active material composite layer may be selected to achieve the benefits, characteristics, and results described herein.

Step 406 of method 400 includes coating a first layer of a composite electrode on a first side of the substrate, on top of the masking applied in step 404. In some examples, the first layer may include a plurality of first particles adhered together by a first binder, the first particles having a first average particle size (or other first particle distribution).

The coating process of step 406 may include any suitable coating method(s), such as slot die, blade coating, spray-based coating, electrostatic jet coating, or the like. In some examples, the first layer is coated as a wet slurry of solvent, e.g., water or NMP(N-Methyl-2-pyrrolidone), binder, conductive additive, and active material. In some examples, the first layer is coated dry, as an active material with a binder and/or a conductive additive. Step 406 may optionally include drying the first layer of the composite electrode.

Step 408 of method 400 includes coating a second layer of a composite electrode, on the first side of the substrate, onto the first layer, forming a multilayered (e.g., stratified) structure. The second layer may include a plurality of second particles adhered together by a second binder, the second particles having a second average particle size (or other second particle distribution).

In some examples, steps 406 and 408 may be performed substantially simultaneously. For example, both of the active material slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the first active material slurry and the second active material slurry may be tailored to cause interpenetrating finger structures at the boundary between the two active material composite layers. In some embodiments, the viscosities, surface tensions, densities, solids contents, and/or solvents may be substantially similar. Creation of interpenetrating structures, if desired, may be facilitated by turbulent flow at the wet interface between the first active material electrode slurry and the second active material electrode slurry, creating partial intermixing of the two active material electrode slurries.

To facilitate proper curing in the drying process, the first layer (closest to the current collector) may be configured to be dried from solvent prior to the second layer (further from the current collector) so as to avoid creating skin-over effects and blisters in the resulting dried coatings.

Method 400 may further include drying the composite electrode in step 410, and/or calendering the composite electrode. Both the first and second layers may experience the drying process and the calendering process as a combined structure. In some examples, step 410 may be combined with calendering (e.g., in a hot roll process). In some examples, drying step 410 includes a form of heating and energy transport to and from the electrode (e.g., convection, conduction, radiation) to expedite the drying process. In some examples, calendering is replaced with another compression, pressing, or compaction process. In some examples, calendering the electrode may be performed by pressing the combined first and second layers against the substrate, such that electrode density is increased in a non-uniform manner, with the first layer having a first porosity and the second layer having a lower second porosity.

Method 400 further includes creating a desired gap pattern in the composite material, i.e., exposing bare substrate, by removing the coated masking material from the substrate. As described above, removal of the masking material may be performed mechanically, manually, automatically, and/or semi-automatically, depending on the tape material and adhesive characteristics.

In some examples and with some gap patterns, similar results may be obtained by replacing steps 404 and 412 with a scraping and/or notching step. This option adds cost (e.g., due to additional equipment). Potential damage or loss of integrity of the current collector may result, as the scraping process usually involves a firm bristle or foam-like material to rub the composite coatings off. If this step is performed prior to calendering, the electrodes may delaminate from the current collector. If this step is performed after calendering, the composite particles are typically embedded into the current collector, making removal more difficult. In some cases, a portion of the current collector may need to be removed to obtain a clean tabbing area with low resistance. Accordingly, although some gap patterns may be achieved by mechanical scraping or notching of the coated substrate, the masking process described above is preferred. Turning to FIG. 5, an illustrative system 500 suitable for use with method 400 will now be described. In some examples, a slot-die coating head with at least two fluid slots, fluid cavities, fluid lines, and fluid pumps may be used to manufacture a battery electrode featuring multiple active material composite layers. System 500 includes a dual-cavity slot-die coating head configured to manufacture electrodes having two layers. In some examples, additional cavities may be used to create additional layers.

System 500 is a manufacturing system in which a foil substrate 502 (e.g., current collector substrate 206, 306, etc.) is transported by a revolving backing roll 504 past a stationary dispenser device 506. Dispenser device 506 may include any suitable dispenser configured to evenly coat one or more layers of active material slurry onto the substrate, as described with respect to steps 406 and 408 of method 400. In some examples, the substrate may be held stationary while the dispenser head moves. In some examples, both may be in motion.

Dispenser device 506 may, for example, include a dual chamber slot die coating device having a coating head 508 with two orifices 510 and 512. A slurry delivery system supplies two different active material slurries to the coating head under pressure. Due to the revolving nature of backing roll 504, material exiting the lower orifice or slot 510 will contact substrate 502 before material exiting the upper orifice or slot 512. Accordingly, a first layer 514 will be applied to the substrate and a second layer 516 will be applied on top of the first layer.

Accordingly, corresponding steps of method 400 may be characterized as follows. Causing a current collector substrate and an active material composite dispenser to move relative to each other, and coating at least a portion of the substrate with an active material composite, using the dispenser. Coating, in this case, includes: applying a first layer of slurry to the substrate using a first orifice or slot of the dispenser, and applying a second layer of a different slurry to the first layer using a second orifice or slot of the dispenser.

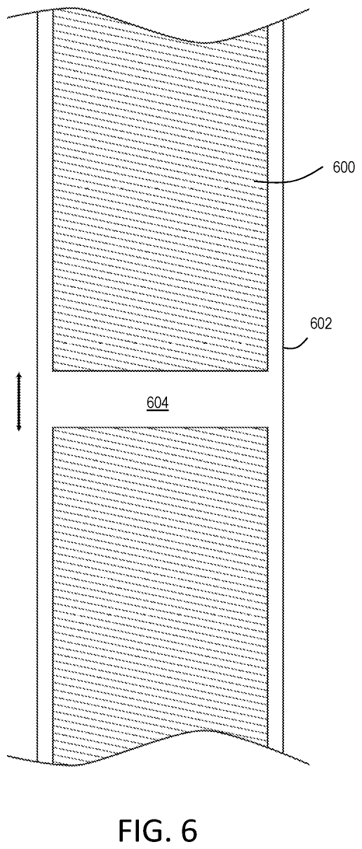

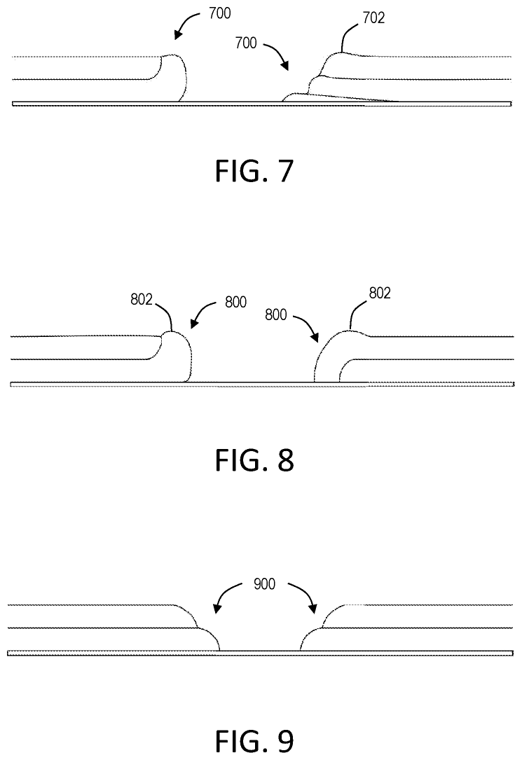

FIG. 6 is an overhead view depicting the general case of an electrode material 600 deposited on a substrate 602 with a gap 604 defined as a bare portion of the substrate between two areas covered by material 600. As explained above, this gap may be produced in standard electrodes by simply stopping and starting the coating process in a controlled manner. However, as depicted in FIGS. 7-9, such a stop/start method can result in undesirable characteristics and features. For example, at the ends of the coated areas, undesired features such as a loss of ML architecture (see areas indicated at 700, 800, and 900) and an upward bulge (see areas indicated at 702 and 802) may be produced.

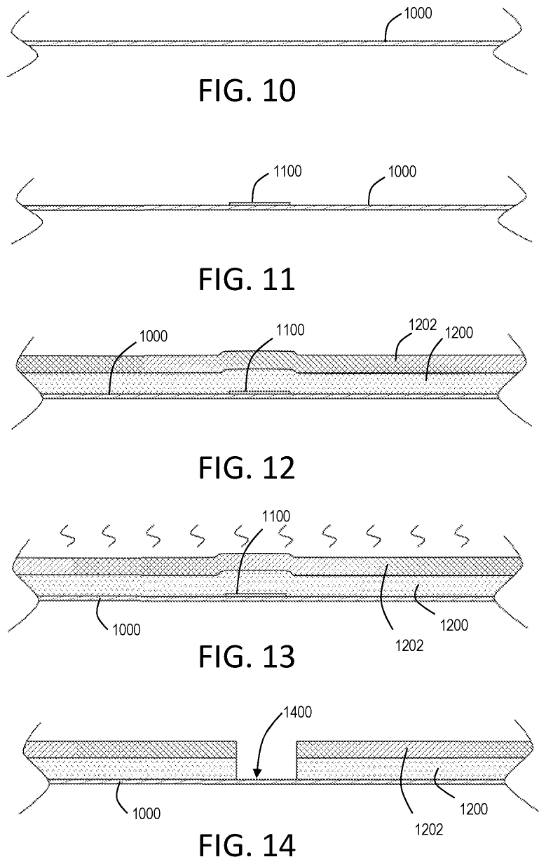

FIGS. 10-14 are schematic side elevation views depicting an electrode being manufactured according to method 400. FIG. 10 depicts a bare substrate 1000, corresponding to step 402. FIG. 11 depicts the substrate with an illustrative mask 1100 applied thereon, corresponding to step 404. FIG. 12 depicts substrate 1000 and mask 1100 with a multilayered composite material (layers 1200, 1202) deposited thereon, corresponding to steps 406 and 408. FIG. 13 depicts the substrate, mask, and composite material, shown drying as in method step 410. FIG. 14 depicts the substrate and composite, with the mask and a portion of the composite removed to create a gap 1400 or bare patch of substrate, corresponding to step 412.

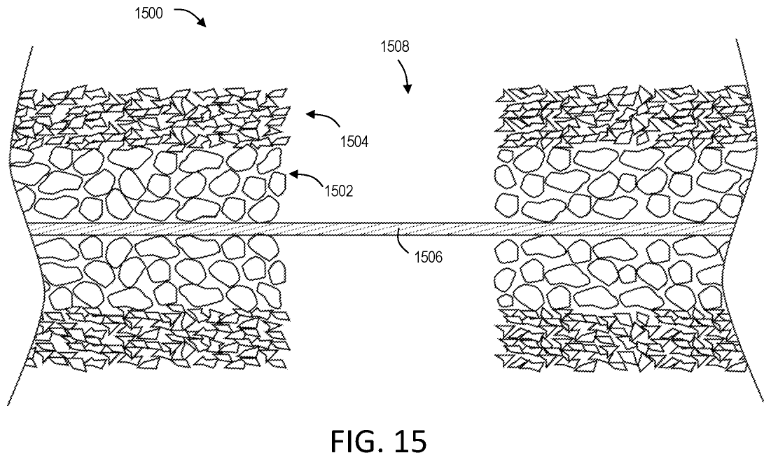

FIG. 15 is a more detailed, schematic, ideal cross section of a ML electrode 1500 having multiple layers 1502, 1504 deposited on a substrate 1506 using a dual-extrusion slot-die coating head and a gap 1508 created using masking in accordance with method 400 or the like.

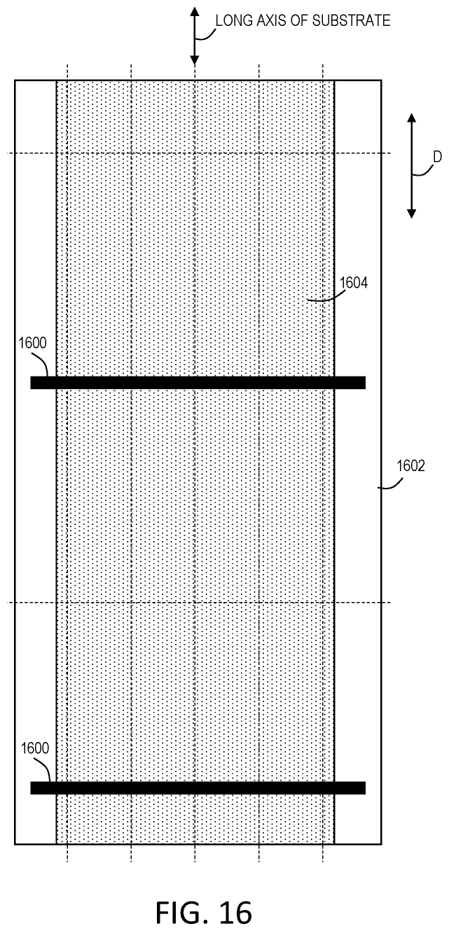

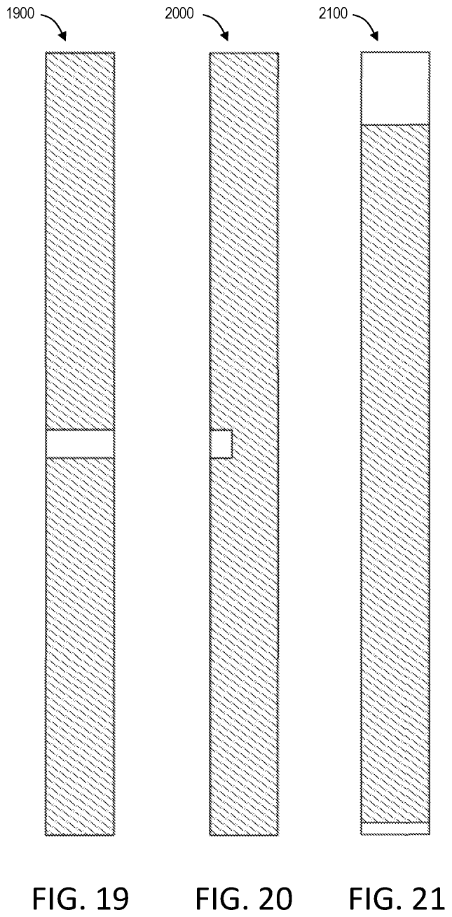

FIGS. 16-18, which correspond respectively to FIGS. 19-21, depict three different masking patterns for producing three different electrode ribbons having different gap topologies. Each of these electrodes may be suitable, for example, as an electrode ribbon (AKA an electrode tape or electrode strip) for use in a wound cylindrical or pouch cell. The illustrations in FIGS. 19-21 are all of electrode ribbons after being slit into the proper width, and also cut to the proper length (e.g., at the dashed lines depicted in FIGS. 16-18).

With reference to FIGS. 16 and 19, an example is shown where the masked portion is a band or strip 1600 on a substrate 1602 coated by a composite (e.g., multilayered) material 1604, leaving a strip in the center of the electrode ribbon for center-of-tape tabbing. This design may be used for cathodes in an 18650 format, for example. In this case, the masking tape is a narrow tape applied orthogonally with respect to the web direction D upon coating. Upon release/removal of the masking tape, slitting, and cutting, the electrode tape has the resulting appearance depicted in FIG. 19, and generally indicated at 1900.

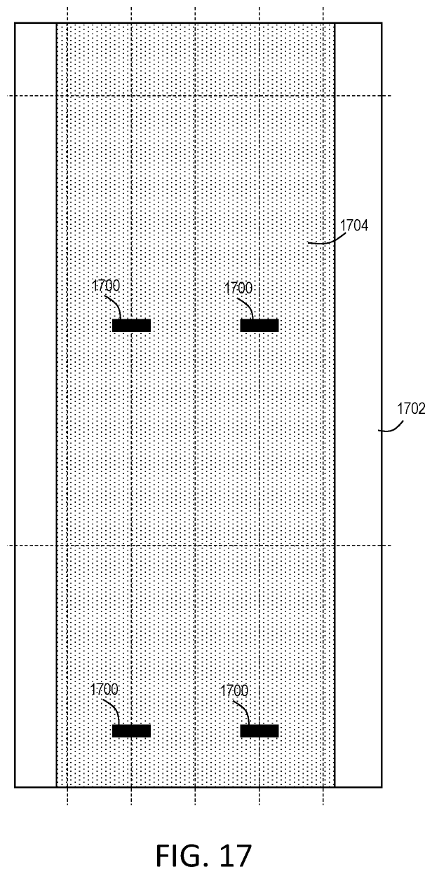

With reference to FIGS. 17 and 20, an example is shown where the mask includes multiple short rectangular portions 1700 disposed partially across a substrate 1702 at preselected (e.g., arbitrary) longitudinal locations, coated by a composite (e.g., multilayered) material 1704. This pattern leaves gaps in the tape for tabbing. As the tabbing area for the ultrasonic weld point need not occupy an entire strip, this type of tabbing area footprint allows maximization of cell energy density due to increased active material area. This pattern is capable of being achieved with tape-masking but not with standard skip-coating, which cannot achieve rectangular, isolated patches of uncoated substrate. Upon release/removal of the masking tape, slitting, and cutting, the electrode tape has the resulting appearance depicted in FIG. 20, and generally indicated at 2000.

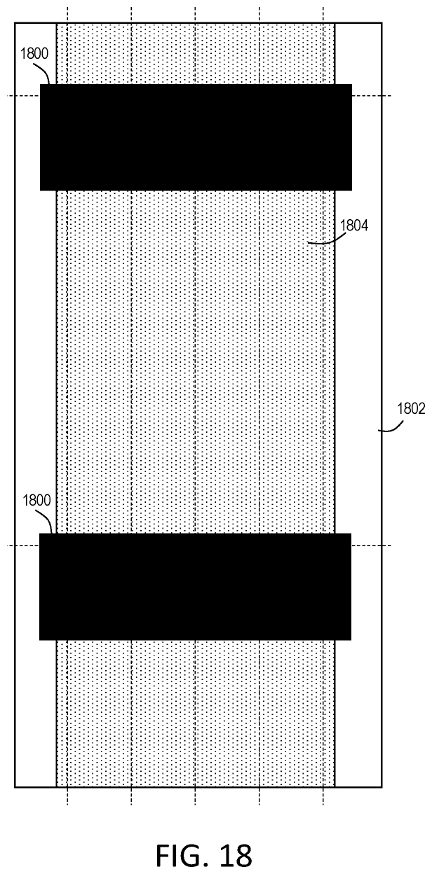

With reference to FIGS. 18 and 21, an example is shown where the mask includes rectangular strips or portions 1800 disposed non-uniformly at the ends of the electrode tape sections (indicated by dashed lines), across a substrate 1802, coated by a composite (e.g., multilayered) material 1804. This design may be used for anodes in an 18650 format, for example. Upon release/removal of the masking tape, slitting, and cutting, the electrode tape has the resulting appearance depicted in FIG. 21, and generally indicated at 2100.

### D. Illustrative Combinations and Additional Examples

This section describes additional aspects and features of electrode manufacturing methods of the present disclosure, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A method of manufacturing an electrochemical cell electrode, the method comprising: applying a mask directly to a current collector substrate in a selected pattern, wherein the mask includes an adhesive tape; adding a multilayer composite coating to the current collector substrate by forming a first layer by coating a first active material composite onto the current collector substrate and the mask, wherein the first active material composite includes a plurality of first active material particles, and forming a second layer by coating a second active material composite onto the first layer, wherein the second active material composite includes a plurality of second active material particles; heating the composite coating such that the first layer, the second layer, and the mask are dried; removing the mask from the current collector substrate, such that corresponding portions of the first layer and the second layer are removed from the current collector substrate and gaps are formed in the composite coating, each of the gaps comprising a bare area of the current collector substrate.

A1. The method of A0, wherein the tape comprises a single-sided, thermal release tape.

A2. The method of A1, wherein the thermal release tape has a forming temperature of approximately 90 degrees Celsius.

A3. The method of any one of paragraphs A0through A2, wherein applying the mask to the current collector substrate in the selected pattern comprises applying a rectangle of tape oriented transverse to a long axis of the substrate.

A4. The method of A3, wherein the rectangle of tape extends completely across the multilayer composite coating.

A5. The method of any one of paragraphs A0 through A4, further comprising cutting the substrate and composite coating lengthwise to form a plurality of electrode ribbons, each including a portion of one of the gaps formed by removing the mask.

A6. The method of A5, wherein each of the electrode ribbons comprises portions of at least two of the gaps formed by removing the mask.

A7. The method of any one of paragraphs A0 through A6, wherein the tape has a film thickness of less than or equal to 15 μm.

A8. The method of A7, wherein the tape comprises a polyethylene terephthalate (PET).

A9. The method of any one of paragraphs A0 through A8, wherein the multilayer composite coating is added to the current collector substrate using a slot die coating device.

B0. A method of manufacturing an electrochemical cell electrode, the method comprising: adhering a mask to a current collector substrate in a selected pattern; adding a multilayer composite coating to the current collector substrate by forming a first layer by coating a first active material composite onto the current collector substrate and the mask, and forming a second layer by coating a second active material composite onto the first layer; heating the composite coating in an oven, such that the first layer, the second layer, and the mask are dried; and removing the mask from the current collector substrate, such that corresponding portions of the first layer and the second layer are removed from the current collector substrate and gaps are formed in the composite coating, each of the gaps comprising a bare area of the current collector substrate.

B1. The method of B0, wherein the mask comprises a thermal release tape.

B2. The method of B1, wherein the thermal release tape has a forming temperature of approximately 90 degrees Celsius.

B3. The method of any one of paragraphs B0 through B2, wherein adhering the mask to the current collector substrate in the selected pattern comprises applying a rectangle of tape oriented transverse to a long axis of the substrate.

B4. The method of any one of paragraphs B0 through B3, wherein the rectangle of tape extends completely across the multilayer composite coating.

B5. The method of any one of paragraphs B0 through B4, further comprising cutting the substrate and composite coating lengthwise to form a plurality of electrode ribbons, each including a portion of one of the gaps formed by removing the mask.

B6. The method of B5, wherein each of the electrode ribbons comprises portions of at least two of the gaps formed by removing the mask.

B7. The method of any one of paragraphs B0 through B6, wherein the mask comprises a tape having a film thickness of less than or equal to 15 μm.

B8. The method of B7, wherein the tape comprises a polyethylene terephthalate (PET).

B9. The method of any one of paragraphs B0 through B8, wherein the multilayer composite coating is added to the current collector substrate using a slot die coating device.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A method of manufacturing an electrochemical cell electrode, the method comprising:
applying a mask directly to a current collector substrate in a selected pattern, wherein the mask includes an adhesive tape;
adding a multilayer composite coating to the current collector substrate by
forming a first layer by coating a first active material composite onto the current collector substrate and the mask, wherein the first active material composite includes a plurality of first active material particles, and
forming a second layer by coating a second active material composite onto the first layer, wherein the second active material composite includes a plurality of second active material particles;
heating the composite coating such that the first layer, the second layer, and the mask are dried;
removing the mask from the current collector substrate, such that corresponding portions of the first layer and the second layer are removed from the current collector substrate and gaps are formed in the composite coating, each of the gaps comprising a bare area of the current collector substrate.

2. The method of claim 1, wherein the tape comprises a single-sided, thermal release tape.

3. The method of claim 2, wherein the thermal release tape has a forming temperature of approximately 90 degrees Celsius.

4. The method of claim 1, wherein applying the mask to the current collector substrate in the selected pattern comprises applying a rectangle of tape oriented transverse to a long axis of the substrate.

5. The method of claim 4, wherein the rectangle of tape extends completely across the multilayer composite coating.

6. The method of claim 1, further comprising cutting the substrate and composite coating lengthwise to form a plurality of electrode ribbons, each including a portion of one of the gaps formed by removing the mask.

7. The method of claim 6, wherein each of the electrode ribbons comprises portions of at least two of the gaps formed by removing the mask.

8. The method of claim 1, wherein the tape has a film thickness of less than or equal to 15 μm.

9. The method of claim 8, wherein the tape comprises a polyethylene terephthalate (PET).

10. The method of claim 1, wherein the multilayer composite coating is added to the current collector substrate using a slot die coating device.

11. A method of manufacturing an electrochemical cell electrode, the method comprising:
adhering a mask to a current collector substrate in a selected pattern;
adding a multilayer composite coating to the current collector substrate by
forming a first layer by coating a first active material composite onto the current collector substrate and the mask, and
forming a second layer by coating a second active material composite onto the first layer;
heating the composite coating in an oven, such that the first layer, the second layer, and the mask are dried;
removing the mask from the current collector substrate, such that corresponding portions of the first layer and the second layer are removed from the current collector substrate and gaps are formed in the composite coating, each of the gaps comprising a bare area of the current collector substrate.

12. The method of claim 11, wherein the mask comprises a thermal release tape.

13. The method of claim 12, wherein the thermal release tape has a forming temperature of approximately 90 degrees Celsius.

14. The method of claim 11, wherein adhering the mask to the current collector substrate in the selected pattern comprises applying a rectangle of tape oriented transverse to a long axis of the substrate.

15. The method of claim 14, wherein the rectangle of tape extends completely across the multilayer composite coating.

16. The method of claim 11, further comprising cutting the substrate and composite coating lengthwise to form a plurality of electrode ribbons, each including a portion of one of the gaps formed by removing the mask.

17. The method of claim 16, wherein each of the electrode ribbons comprises portions of at least two of the gaps formed by removing the mask.

18. The method of claim 11, wherein the mask comprises a tape having a film thickness of less than or equal to 15 μm.

19. The method of claim 18, wherein the tape comprises a polyethylene terephthalate (PET).

20. The method of claim 11, wherein the multilayer composite coating is added to the current collector substrate using a slot die coating device.
